(19) United States
(12) Patent Application Publication
(10) Pub. No.: US 2009/0084647 A1
(43) Pub. Date: Apr. 2, 2009

(54) Damping force adjusting structure of hydraulic shock absorber

(75) Inventors: Noriaki Maneyama, Saitama (JP); Takashi Tsukahara, Saitama (JP); Seiryo Konakai, Saitama (JP)

Correspondence Address: Orum & Roth LLC, 53 W. Jackson Blvd., Chicago, IL, 60604-3606, US

(73) Assignee: SHOWA CORPORATION

(21) Appl. No.: 12/075,780

(22) Filed: Mar. 13, 2008

(30) Foreign Application Priority Data
Sep. 27, 2007 (JP) 2007-252329

(51) Int. Cl. F16F 9/14

(52) U.S. Cl. 188/314

(57) ABSTRACT

In a damping force adjusting structure of a hydraulic shock absorber, a blow valve blowing an oil liquid in a rod side chamber to a back pressure chamber is provided in a back pressure introduction path introducing the oil liquid in the rod side chamber to the back pressure chamber, and a blow valve has a first pressure receiving portion capable of receiving the pressure of the rod side chamber before and after the valve opening, and a second pressure receiving portion capable of receiving the pressure of the rod side chamber after the valve opening.

### BACKGROUND OF THE INVENTION

1. Field of the Invention

The present invention relates to a damping force adjusting structure of a hydraulic shock absorber.

2. Description of the Related Art

In a damping force adjusting structure of a hydraulic shock absorber, there is a structure provided with a cylinder in which an oil liquid is sealed. Further components include a piston slidably fitted into the cylinder, a piston rod having one end coupled to the piston and the other end extended out to an outer portion of the cylinder, and a main disc valve which generates a damping force by controlling the flow of the oil liquid generated by a sliding motion of the piston. A back pressure chamber applies an internal pressure in a valve closing direction of the main disc valve, and introduces a part of the oil liquid to the back pressure chamber and controlling the valve opening of the main disc valve, as described in Japanese Patent Application Laid-Open (JP-A) No. 2005-344734 (patent document 1). In this damping force adjusting structure, a pilot oil path introducing the oil liquid to the back pressure chamber is pierced in the main disc valve, and a sub valve directly opening and closing the pilot oil path is provided in a back surface side of the main disc valve. When the sub valve closes the pilot oil path, internal pressure of the back pressure chamber is not increased. Accordingly, the valve opening pressure of the main disc valve becomes low, and the damping force becomes low. When the sub valve opens the pilot oil path, the internal pressure of the back pressure chamber is increased. Accordingly, the valve opening pressure of the main disc valve becomes high, and the damping force becomes high.

In the damping force adjusting structure described in the patent document 1, the pilot oil path pierced in the main disc valve is set to a back pressure introduction path to the back pressure chamber, and the back pressure introduction path is opened and dosed by the sub disc valve. The pressure of the back pressure chamber is set on the basis of a valve rigidity of the sub disc valve and a magnitude of the pilot oil path of the main disc valve, and it is subsequently difficult to control the pressure of the back pressure chamber.

In other words, if the piston moving speed is increased and the one oil chamber is pressurized, the sub disc valve is opened and the pressure of the back pressure chamber is increased, whereby the damping force becomes high. However, if the piston moving speed is decreased, the pressure of the one oil chamber is lowered, the sub disc valve is closed, and the pressure of the back pressure chamber is decreased, whereby the damping force becomes low. Accordingly, regarding the behavior of a corresponding vehicle, for example, since the piston moving speed is high just after turning the steering wheel during cornering, the sub disc valve is opened so as to form a high damping force, so that it is possible to control rolling. However, after a midfield of the cornering, since the piston moving speed become low, the sub disc valve is closed. Accordingly, the damping force becomes low and rolling is generated. In this case, it is difficult or impossible to control the rolling of the vehicle.

### SUMMARY OF THE INVENTION

An object of the present invention is to keep increasing pressure of a back pressure chamber so as to maintain a high damping force when piston moving speed is increased during a period of controlling the pressure of the back pressure chamber provided in a back surface side of a damping valve so as to adjust a damping force, in a damping force adjusting structure of a hydraulic shock absorber.

The present invention relates to a damping force adjusting structure of a hydraulic shock absorber. A damping force is generated by accommodating an oil liquid in an oil chamber of a cylinder, slidably fitting and inserting a piston provided in an insertion end of a piston rod inserted to the cylinder to the cylinder, and controlling the flow of an oil liquid from one oil chamber to the other oil chamber pressurized by a sliding motion of the piston by a damping valve. The pressurized oil liquid is introduced in the one oil chamber to a back pressure chamber provided in a back surface side of a damping valve. Pressure within the back pressure chamber is leaked from a leak path, and a valve opening pressure of the damping valve is controlled by controlling the pressure of the back pressure chamber so as to be capable of adjusting the damping force. A blow valve blowing the oil liquid in the pressurized one oil chamber to the back pressure chamber is provided in a back pressure introduction path introducing the pressurized oil liquid in the one oil chamber to the back pressure chamber. The blow valve has a first pressure receiving portion capable of receiving the pressure of the one oil chamber before and after the valve opening, and a second pressure receiving portion capable of receiving the pressure of the one oil chamber after the valve opening.

### BRIEF DESCRIPTION OF THE DRAWINGS

The present invention will be more fully understood from the detailed description given below and from the accompanying drawings which should not be taken to be a limitation on the invention, but are for explanation and understanding only.

FIG. 1 is a schematic cross sectional view showing a hydraulic shock absorber in accordance with an embodiment 1;

FIG. 2 is a schematic cross sectional view showing a valve closed state of a blow valve in the hydraulic shock absorber;

FIG. 3 is a schematic cross sectional view showing a valve opened state of the blow valve in the hydraulic shock absorber;

FIG. 4 is a schematic cross sectional view showing a hydraulic shock absorber in accordance with an embodiment 2;

FIG. 5 is a schematic cross sectional view showing a hydraulic shock absorber in accordance with an embodiment 3; and

FIG. 6 is a schematic cross sectional view showing a hydraulic shock absorber in accordance with an embodiment 4.

### DESCRIPTION OF THE PREFERRED EMBODIMENTS

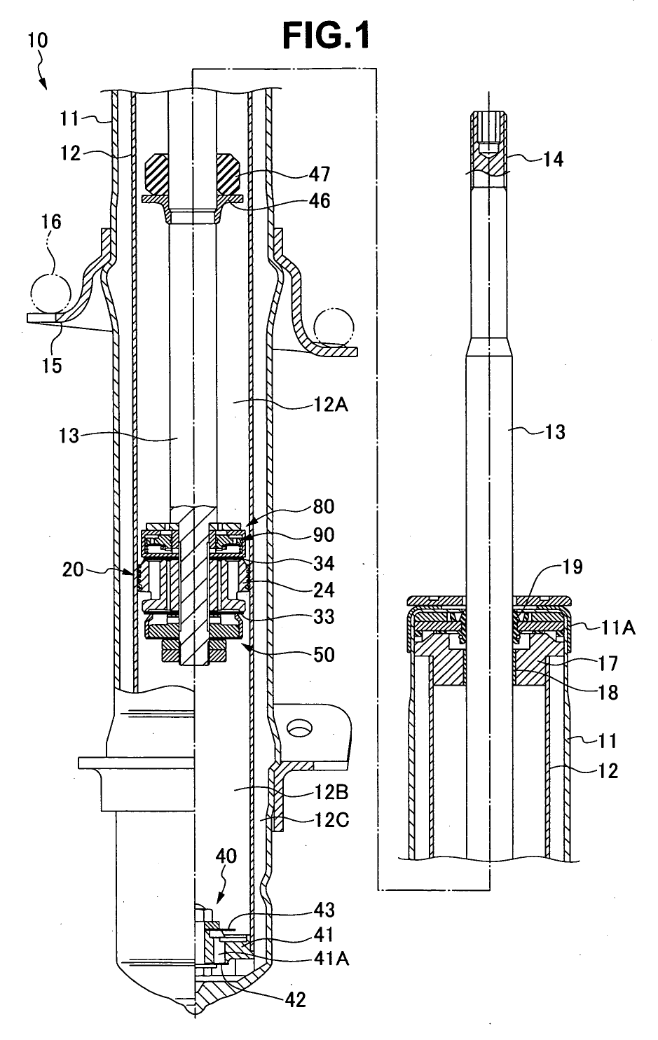

### (Embodiment 1) (FIGS. 1 to 3)

The damping force adjusting type hydraulic shock absorber 10 is of a double cylinder type in which a damper tube 11 has a cylinder 12 built-in, as shown in FIG. 1. It is structured such that a piston rod 13 is inserted to the cylinder 12 accommodating an oil liquid therein, an axle side attaching portion is provided in a lower portion of the damper tube 11, and a vehicle body side attaching portion 14 is provided in an upper portion of the piston rod 13, thereby constructing a suspension apparatus of a vehicle.

The hydraulic shock absorber 10 interposes a suspension spring 16 between a lower spring seat 15 in an outer periphery of the damper tube 11, and an upper spring seat (not shown) provided in the vehicle body side attaching portion 14 in the upper end portion of the piston rod 13.

The hydraulic shock absorber 10 pinches and fixes a rod guide 17, a bush 18 and an oil seal 19 for the piston rod 13 inserted to the cylinder 12 between an upper end caulking portion 11A of the damper tube 11 and an upper end portion of the cylinder 12.

The damping force adjusting type hydraulic shock absorber 10 has a piston valve apparatus 20 and a bottom valve apparatus 40. The piston valve apparatus 20 and the bottom valve apparatus 40 controls oil liquid flow generated by a sliding motion of the cylinder 12 by a piston 24 mentioned below provided in an insertion end of the piston rod 13 to the cylinder 12 so as to generate a damping force, and the damping force generated thereby controls a stretching vibration of the piston rod 13 caused by an absorption of an impact force by the suspension spring 16.

### (Piston Valve Apparatus 20)

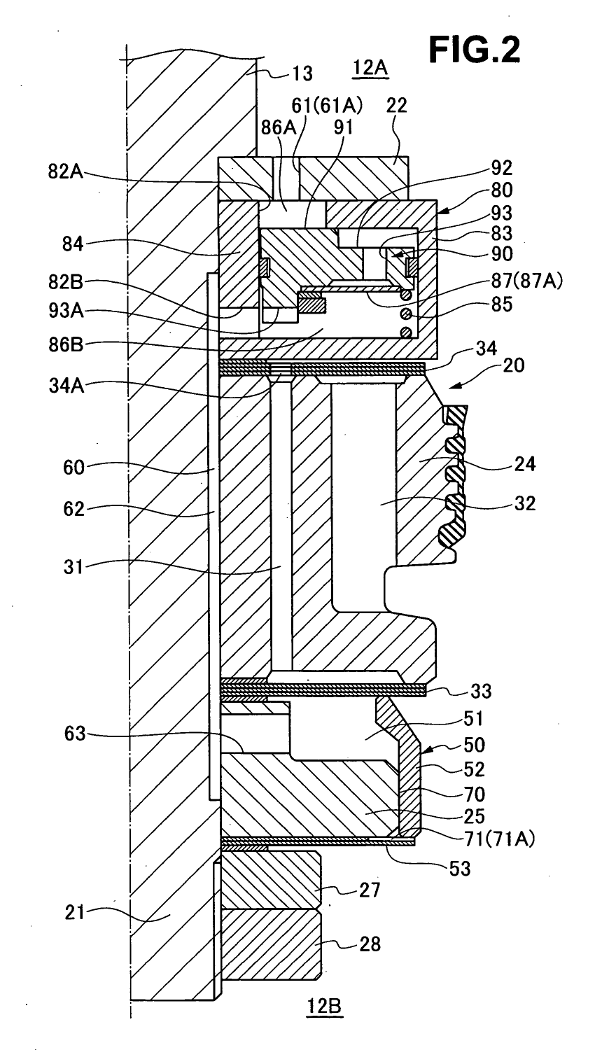

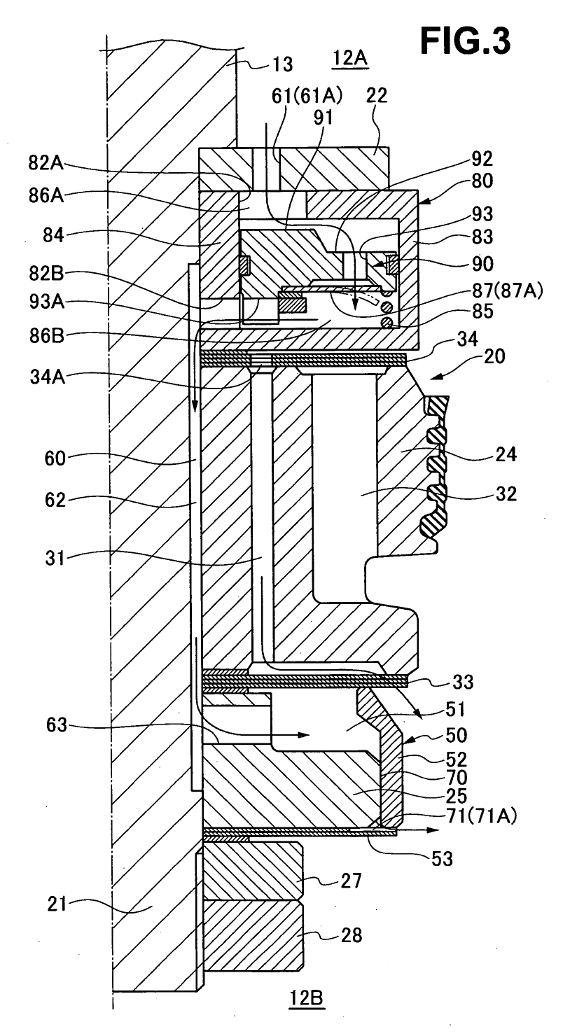

The piston valve apparatus 20 has a thread portion 21 in an outer periphery of an insertion end of the piston rod 13 to the cylinder 12, as shown in FIGS. 2 and 3. It is structured such that a spacer 22, a valve case 80 for a blow valve 90 mentioned below, the piston 24, a valve stopper 25 and a spacer 27 are installed to an outer periphery of the thread portion 21, and they are pinched and fixed with respect to a base end step portion of the thread portion 21 by a nut 28 screwed to the thread portion 21.

The piston 24 is slidably fitted and inserted to the cylinder 12, and is provided with an, expansion side flow path 31 and a compression side flow path 32. An annular center portion of a disc valve shaped expansion side damping valve 33 is pinched between the piston 24 and the valve case 52, and an annular center portion of a disc valve shaped compression side damping valve 34 is pinched between the piston 24 and the valve stopper 23. In other words, the piston valve apparatus 20 compartmentalizes an inner side of the cylinder 12 into a rod side chamber 12A and a piston side chamber 12B by the piston 24. The rod side chamber 12A and the piston side chamber 12B are communicated respectively via the expansion side flow path 31 provided in the piston 24 and the expansion side damping valve 33 opening and closing the expansion side flow path 31, and the compression side flow path 32 and the compression side damping valve 34 opening and closing the compression side flow path 32. The compression side damping valve 34 is provided with a hole 34A communicating the rod side chamber 12A with the expansion side flow path 31.

Accordingly, during expansion, the oil in the rod side chamber 12A passes through the expansion side flow path 31 of the piston 24 from the hole 34A of the compression side damping valve 34. Deflection deforms the expansion side damping valve 33 so as to open, and oil is guided to the piston side chamber 12B and generates the expansion side damping force, as shown in FIG. 3. Further, during compression, the oil in the piston side chamber 12B passes through the compression side flow path 32 of the piston 24. Deflection deforms the compression side damping valve 34 so as to open, and oil is guided to the rod side chamber 12A and generates the compression side damping force.

### (Bottom Valve Apparatus 40)

The hydraulic shock absorber 10 is structured such that a reservoir chamber 12C is formed in a gap between the damper tube 11 and the cylinder 12, and an inner portion of the reservoir chamber 12C is compartmentalized into an oil chamber and a gas chamber. Further, the bottom valve apparatus 40 is structured such that a bottom piece 41 compartmentalizes a piston side chamber 12B and the reservoir chamber 12C in an inner portion of the cylinder 12 is arranged between a lower end portion of the cylinder 12 and a bottom portion of the damper tube 11. A space between the bottom portion of the damper tube 11 and the bottom piece 41 can be communicated with the reservoir chamber 12C by a flow path provided in the bottom piece 41.

The bottom valve apparatus 40 is provided with a disc valve 42 and a check valve 43 serving as bottom valves respectively opening and closing a compression side flow path 41A and an expansion side flow path (not shown) provided in the bottom piece 41.

Further, during expansion, oil at a retracting volumetric capacity of the piston rod 13 retracting from the cylinder 12 pushes open the check valve 43, and is supplied to the piston side chamber 12B via the expansion side flow path (not shown) of the bottom piece 41 from the reservoir chamber 12C. During compression, oil at an approaching volumetric capacity of the piston rod 13 going into the cylinder 12 passes through the compression side flow path 41A of the bottom piece 41 from the piston side chamber 12B so as to deflection deform and open the disc valve 42, and is pushed out to the reservoir chamber 12C, whereby a compression side damping force is obtained.

In this case, the hydraulic shock absorber 10 is provided with a rebound rubber 47 compression deformed during a period when the piston rod 13 is extended (in a state of a maximum extension of the hydraulic shock absorber 10), on a rebound seat 46 fixed to a side (a lower side) of the piston 24, around the piston rod 13 positioned in the rod side chamber 12A of the cylinder 12.

Accordingly, the hydraulic shock absorber 10 is provided with an expansion side damping force adjusting apparatus 50 for adjusting an expansion side damping force of the piston valve apparatus 20 in the following manner.

The expansion side damping force adjusting apparatus 50 is provided with an expansion side back pressure chamber 51 in a back surface side with respect to the expansion side flow path 31 of the expansion side damping valve 33, as shown in FIGS. 2 and 3. In the present embodiment, the expansion side back pressure chamber 51 is formed by an outer periphery diameter-reduced portion of the valve stopper 25 provided in the back surface of the expansion side damping valve 33. A backup collar 52 is provided in an outer periphery of the valve stopper 25 so as to slide via a sliding gap forming a leak path 70 mentioned below. A front surface of the backup collar 52 is energized and pressed to the expansion side damping valve 33 by an annular plate spring 53 (a spring) provided in a back surface of the backup collar 52. At this time, it is preferable to make a pressure receiving area in which the expansion side damping valve 33 facing the expansion side flow path 31 equal to or slightly larger than a pressure receiving area facing to the expansion side back pressure chamber 51.

The expansion side damping force adjusting apparatus 50 is provided with a back pressure introduction path 60 communicating the rod side chamber 12A with the expansion side back pressure chamber 51 in an insertion end of the piston rod 13. The back pressure introduction path 60 is formed in such a manner as to sequentially communicate an inlet passage 61 provided in the spacer 22, an inlet 82A and an outlet 82B of a blow valve 90 mentioned below, a vertical groove 62 provided in the insertion end of the piston rod 13, and a horizontal hole 63 provided in the valve stopper 25, and to open the inlet passage 61 of the spacer 22 to the rod side chamber 12A and open the horizontal hole 63 to the expansion side back pressure chamber 51.

The expansion side damping force adjusting apparatus 50 introduces a part of the oil liquid of the rod side chamber 12A to the expansion side back pressure chamber 51 provided in the back surface side of the expansion side damping valve 33 from the back pressure introduction path 60, leaks the pressure within the back pressure chamber 51 to the piston side chamber 12B from the leak path 70, and controls the pressure of the expansion side back pressure chamber 51, thereby controlling the valve opening pressure of the expansion side damping valve 33 and adjusting the expansion side damping force.

In this case, in the expansion side damping force adjusting apparatus 50, an introduction side orifice 61A can be provided in an inlet passage 61 from the rod side chamber 12A to the blow valve 90, which is provided as a part of the back pressure introduction path 60 in the space 22.

When the piston speed (the moving speed of the piston 24) of the hydraulic shock absorber 10 reaches a high-frequency input, the oil liquid of the rod side chamber 12A is difficult to introduce to the side of the blow valve 90 and the expansion side back pressure chamber 51 on the basis of a resistance of the introduction side orifice 61A, and the pressure of the back pressure chamber 51 is not increased. In the case that the piston speed of the hydraulic shock absorber 10 reaches a low-frequency input, the oil liquid of the rod side chamber 12A easily passes through the introduction side orifice 61A so as to be easily introduced to the blow valve 90 and the expansion side back pressure chamber 51, and the pressure of the back pressure chamber 51 is increased.

Further, in the expansion side damping force adjusting apparatus 50, the backup collar 52 forms a sliding gap between the backup collar 52 and the valve stopper 25, and constructs a leak path 70 leaking the pressure of the expansion side back pressure chamber 51 to the piston side chamber 12B by this sliding gap. At this time, the plate spring 53 mentioned above and pressing the backup collar 52 from the back surface, is provided with a slit 71 at one position or a plurality of positions in a circumferential direction of an outer edge of a thin plate in an uppermost layer side which directly comes into contact with the backup collar 52, and a leak side orifice 71A can be formed by the slit 71.

The expansion side damping force adjusting apparatus 50 creates a flow path area of the leak side orifice 71A smaller than the introduction side orifice 61A, and maintains the pressure of the expansion side back pressure chamber 51 introduced via the introduction side orifice 61A constant by a resistance of the leak side orifice 71A.

Accordingly, the expansion side damping force adjusting apparatus 50 is actuated as follows.

(1) When the piston speed (the moving speed of the piston 24) of the hydraulic shock absorber 10 reaches a high-frequency input, the oil liquid of the rod side chamber 12A is difficult to introduce to the side of the blow valve 90 and the expansion side back pressure chamber 51 on the basis of the resistance of the introduction side orifice 61A provided in the inlet passage 61 of the space 22, and the pressure of the back pressure chamber 51 is not increased. Accordingly, the valve opening pressure of the expansion side damping valve 33 becomes low, the expansion side damping valve 33 is easily opened, and the expansion side damping force of the expansion side damping valve 33 becomes low.

(2) When the piston speed of the hydraulic shock absorber 10 reaches a low-frequency input, the oil liquid of the rod side chamber 12A easily passes through the introduction side orifice 61A so as to be easily introduced to the side of the blow valve 90 and the expansion side back pressure chamber 51. The pressure of the back pressure chamber 51 is increased on the basis of a control motion as mentioned below of the blow valve 90, the valve opening pressure of the expansion side damping valve 33 becomes high, the expansion side damping valve 33 is difficult to open, and the expansion side damping force of the expansion side damping valve 33 becomes high, as shown in FIG. 3.

(3) The pressure of the expansion side back pressure chamber 51 is leaked to the piston side chamber 12B from the leak side orifice 71A provided in the spring 53 via the leak path 70 between the valve stopper 25 and the backup collar 52. A leak amount of the pressure of the expansion side back pressure chamber 51 is stably controlled by the leak side orifice 71A. It is thereby possible to maintain the pressure of the back pressure chamber 51 constant, and it is possible to stably maintain the damping force characteristic of the expansion side damping valve 33.

Accordingly, in the expansion side damping force adjusting apparatus 50, to increase the pressure of the expansion side back pressure chamber 51 so as to maintain the high damping force of the expansion side damping valve 33 when the piston speed of the hydraulic shock absorber 10 is increased, the blow valve 90 blowing the oil liquid having the fixed pressure or higher of the rod side chamber 12A to the back pressure chamber 51 is provided in the inner portion of the valve case 80 interposed in the back pressure introduction path 60 mentioned above, for introducing the oil liquid of the rod side chamber 12A to the back pressure chamber 51.

The blow valve 90 is incorporated in the valve case 80 mentioned above and is installed to the outer periphery of the piston rod 13 so as to be fixed. The valve case 80 is structured such that a hollow shaft 84 provided in the center portion of a tube box 83 in which both upper and lower ends are closed is installed to the outer periphery of the piston rod 13. The valve case 80 is provided with the inlet 82A communicating with the rod side chamber 12A via the inlet passage 61 of the spacer 22 in a top plate of the tube box 83, and is provided with the outlet 82B communicating with the back pressure introduction path 60 of the piston rod 13 in the hollow shaft 84. The blow valve 90 is formed as an annular body sliding in a liquid tight manner with each of an inner periphery of the tube box 83 of the valve case 80 and an outer periphery of the hollow shaft 84 via a seal member. The blow valve 90 is formed as a two-stage structure constituted by a first pressure receiving portion 91 facing to the inlet 82A of the valve case 80 while forming a high step shape in an inner peripheral side, and a second pressure receiving portion 92 forming a lower step shape than the first pressure receiving portion 91 in an outer peripheral side of the first pressure receiving portion 91, in an upper end surface of the annular body. The blow valve 90 is formed so as to pass through a passage 93 conducting an upper chamber 86A corresponding to side communicating with the rod side chamber 12A and a lower chamber 86B corresponding to a side communicating with the back pressure chamber 51 in the valve case 80 during opening of the valve, up and down the annular body within the second pressure receiving portion 92. The blow valve 90 is structured such that a valve spring 85 is interposed between a lower end surface of the annular body and a lower plate of the tube box 83. An outer peripheral edge of the first pressure receiving portion 91 is brought into pressure contact with an opening edge of the inlet 82A by a spring force of the valve spring 85, thereby being closed. Accordingly, the blow valve 90 receives the pressure of the rod side chamber 12A in the first pressure receiving portion 91 before opening the valve (at a period of closing the valve) and after opening the valve, and receives the pressure of the rod side chamber 12A in the second pressure receiving portion 92 after opening the valve. In this case, the blow valve 60 is provided with a passage 93A communicating with the outlet 82B of the valve case 80 in a boss portion provided in a lower end surface of the annular body sliding with the outer periphery of the hollow shaft 84 of the valve case 80.

The blow valve 90 is accessorily provided with a differential pressure generating means 87 lowering the pressure of the lower chamber 86B corresponding to the side communicating with the back pressure chamber 51 with respect to the pressure of the upper chamber 86A corresponding to the side communicating with the rod side chamber 12A, after the valve opening. The differential pressure generating means 87 in accordance with the present embodiment is constructed by a plate valve 87A. The plate valve 87A comprises an annular plate additionally provided in a lower end surface of an annular body of the blow valve 90. The plate valve 87A fixes the annular center portion of the annular plate around the boss portion provided in the lower end surface of the annular body of the blow valve 90, and closes the passage 93 of the blow valve 90 by the annular portion in the deflection deformable outer peripheral side. The plate valve 87A makes the pressure of the lower chamber 86B lower than the pressure of the upper chamber 86A on the basis of a deflection resistance loss which the plate valve 87A applies to the oil liquid flowing to the lower chamber 86B from the upper chamber 86A via the passage 93 while deflection deforming the plate valve 87A after opening the blow valve 90.

Accordingly, the hydraulic shock absorber 50 is provided with the blow valve 90 and is actuated as follows (FIGS. 2 and 3).

(1) If the piston moving speed V/P is increased and the pressure of the rod side chamber 12A or the piston side chamber 12B is increased in the expansion and contraction stroke of the hydraulic shock absorber 10, the expansion side damping valve 33 and the compression side damping valve 34 are opened, and the expansion side damping force TF and the compression side damping force CF are generated.

(2) If the piston moving speed V/P is further increased so as to reach a fixed speed in the expansion stroke of the hydraulic shock absorber 10, and the pressure of the rod side chamber 12A is increased so as to reach a fixed pressure (a valve opening pressure of the blow valve 90), the blow valve 90 receives the pressure in the first pressure receiving portion 91 (a narrow pressure receiving surface) so as to be opened (FIG. 3). The blow valve 90 blows the high-pressure oil liquid of the rod side chamber 12A to the back pressure chamber 51 of the expansion side damping valve 33 via the upper chamber 86A of the valve case 80, the passage 93 of the blow valve 90, the lower chamber 86B of the valve case 80, the back pressure introduction path 60 and the like. Accordingly, the pressure of the back pressure chamber 51 is increased, and the damping force by the expansion side damping valve 33 becomes higher.

(3) After the valve opening mentioned in the item (2) of the blow valve 90, the pressure of the rod side chamber 12A is lowered by blowing, and is further lowered by the low speed of the piston moving speed V/P. However, the blow valve 90 receives the lowered pressure of the rod side chamber 12A by both (a wide pressure receiving surface) the first pressure receiving portion 91 and the second pressure receiving portion 92 so as to keep opening.

Further, after the valve opening mentioned in the item (2) of the blow valve 90, the differential pressure generating means 87 constituted by the plate valve 87A lowers the pressure of the lower chamber 86B with respect to the pressure of the upper chamber 86A. The differential pressure between the upper chamber 86A and the lower chamber 86B keeps opening the blow valve 90, and keeps increasing the pressure of the back pressure chamber 51 by extension, thereby maintaining the damping force by the expansion side damping valve 33 at a high level.

In accordance with the present embodiment, the following operations and effects can be achieved.

(a) In the damping force adjusting structure of the hydraulic shock absorber 10, the blow valve 90 is provided in the back pressure introduction path 60 introducing the oil liquid of the pressurized rod side chamber 12A to the expansion side back pressure chamber 51 during a period of controlling the pressure of the expansion side back pressure chamber 51 provided in the back surface side of the expansion side damping valve 33, so as to adjust the damping force. Accordingly, if the piston moving speed reaches the fixed speed, and the pressure of the rod side chamber 12A reaches the valve opening pressure of the blow valve 90, the blow valve 90 is opened so as to blow the high-pressure oil liquid of the rod side chamber 12A to the expansion side back pressure chamber 51. The pressure of the expansion side back pressure chamber 51 is increased, whereby the damping force generated by the expansion side damping valve 33 becomes high.

(b) At this time, the blow valve 90 has the first pressure receiving portion 91 capable of receiving the pressure of the rod side chamber 12A before and after opening the valve, and the second pressure receiving portion 92 capable of receiving the pressure of the rod side chamber 12A after opening the valve (two staged pressure receiving surface). Accordingly, the blow valve 90 receives the pressure of the rod side chamber 12A only by the first pressure receiving portion 91 (the narrow pressure receiving surface) until the pressure of the rod side chamber 12A reaches the valve opening pressure of the blow valve 90 so as to be opened. The valve opening pressure of the blow valve 90 is defined by the valve spring 85 and an area of the first pressure receiving portion 91. After the blow valve 91 is opened, the pressure of the rod side chamber 12A is lowered by blowing, and is lowered by the low speed of the piston moving speed. However, the blow valve 90 receives the lowered pressure of the rod side chamber 12A by both (the wide pressure receiving surface) of the first pressure receiving portion 91 and the second pressure receiving portion 92, so as to keep opening. Accordingly, the blow valve 90 stably keeps opening (does not generate any unstable pulsation repeating opening and closing) after being once opened, and keeps increasing the pressure of the expansion side back pressure chamber 51, thereby maintaining the damping force generated by the expansion side damping valve 33.

(c) In a behavior of the vehicle, since the piston moving speed is high just after turning the steering wheel, for example, during cornering, the blow valve 90 is opened to generate the high damping force and to control the rolling. Further, if the piston moving speed becomes low after the midfield of the cornering, the blow valve 90 is kept open by the two staged pressure receiving surface mentioned above of the blow valve 90, and rolling is controlled by maintaining the high damping force.

(d) In the present invention, where the piston moving speed is low, the ride quality is improved by a soft damping force characteristic having a low rigidity of the expansion side damping valve 33 itself without increasing the pressure of the expansion side back pressure chamber 51. Further, where the piston moving speed is high, the damping force is increased by increasing the pressure of the expansion side back pressure chamber 51 so as to increase the deflection rigidity of the expansion side damping valve 33, and steering stability is improved.

(e) The blow valve 90 is provided with the differential pressure generating means 87 lowering the pressure in the side communicating with the piston side chamber 12B of the blow valve 90, with respect to the pressure in the side communicating with the rod side chamber 12A of the blow valve 90 after being opened. Even if the pressure of the rod side chamber 12A is further lowered than the item (b) mentioned above, it is possible to keep opening the blow valve 90 on the basis of the differential pressure.

(f) Since the differential pressure generating means 87 comprises the plate valve 87A, it is possible to generate the differential pressure by setting the deflection rigidity of the plate valve 87A, and it is possible to keep opening the blow valve 90.

(g) Since the introduction side orifice 61A is provided in the inlet passage 61 from the rod side chamber 12A to the blow valve 90, it is possible to delay pressure propagation from the rod side chamber 12A to the blow valve 90. Further, in the case that the piston moving speed reaches a high frequency, it is possible to carry out a frequency depending type damping force adjustment maintaining the valve closing of the blow valve 90 without transmitting the pressure of the rod side chamber 12A to the blow valve 90.

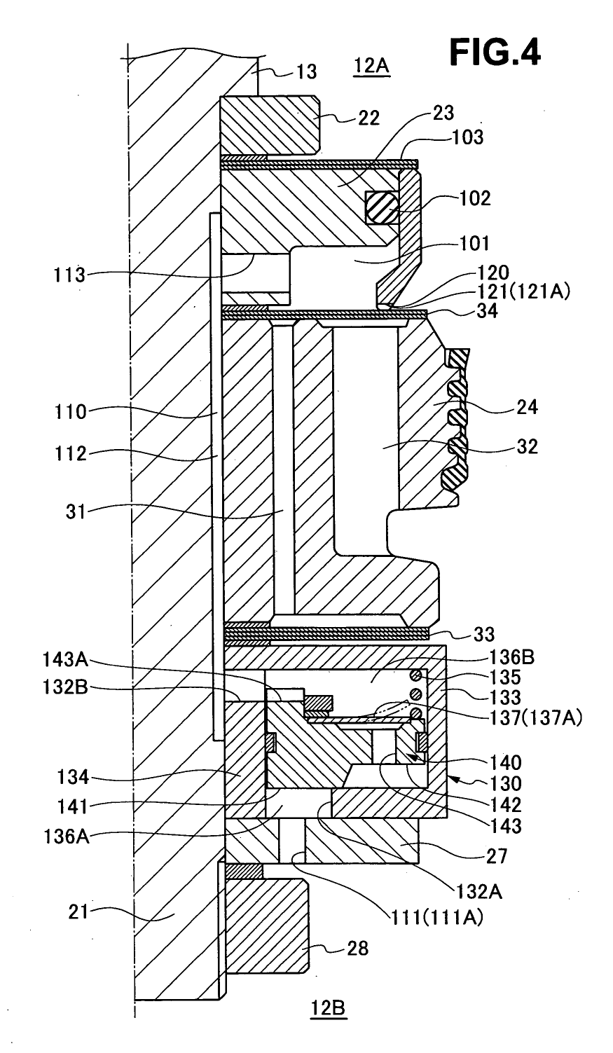

### (Embodiment 2) (FIG. 4)

The hydraulic shock absorber 10 shown in FIG. 4 is provided with a compression side damping force adjusting apparatus 100 for adjusting the compression side damping force of the piston valve apparatus 20. In this case, in the piston valve apparatus 20 of the hydraulic shock absorber 10, the spacer 22, the valve stopper 23, the compression side damping valve 34, the piston 24, the expansion side damping valve 33, a valve case 130 for a blow valve 140 mentioned below and the spacer 27 are installed to the outer periphery of the thread portion 21 of the piston rod 13. They are pinched and fixed with respect to the base end step portion of the thread portion 21 by a nut 28 engaged with the thread portion 21.

The compression side damping force adjusting apparatus 100 is provided with a compression side back pressure chamber 101 in a back surface side with respect to the compression side flow path 32 of the compression side damping valve 34, as shown in FIG. 4. In the present embodiment, the compression side back pressure chamber 101 is formed by an outer periphery diameter-reduced portion of the valve stopper 23 provided in the back surface of the compression side damping valve 34, and a backup collar 102 provided in an outer periphery of the valve stopper 23, so as to slide via a seal member. A front surface of the backup collar 102 is energized and pressed to the compression side damping valve 34 by an annular plate spring 103 (a spring) provided in a back surface of the backup collar 102. At this time, it is preferable to make a pressure receiving area in which the compression side damping valve 34 faces the compression side flow path 32 equal to or slightly larger than a pressure receiving area facing the compression side back pressure chamber 101.

The compression side damping force adjusting apparatus 100 is provided with a back pressure introduction path 110 communicating the piston side chamber 12B with the compression side back pressure chamber 101 in an insertion end of the piston rod 13. The back pressure introduction path 110 is formed in such a manner as to sequentially communicate an inlet passage 111 provided in the spacer 27, an inlet 132A and an outlet 132B of a blow valve 140 mentioned below, a vertical groove 112 provided in the insertion end of the piston rod 13, and a horizontal hole 113 provided in the valve stopper 23, and open the inlet passage 111 of the spacer 27 to the piston side chamber 12B, and open the horizontal hole 113 to the compression side back pressure chamber 101.

The compression side damping force adjusting apparatus 100 introduces a part of the oil liquid of the piston side chamber 12B to a compression side back pressure chamber 101 provided in the back surface side of the compression side damping valve 34 from a back pressure introduction path 110. Pressure is leaked within the back pressure chamber 101 to the rod side chamber 12A from a slit-shaped leak path 120 provided in a part in a circumferential direction of a leading end portion pressed to the compression side damping valve 34 of a backup collar 102. The pressure of the compression side back pressure chamber 101 is controlled, thereby controlling the valve opening pressure of the compression side damping valve 34 and adjusting the compression side damping force.

In this case, in the compression side damping force adjusting apparatus 100, an introduction side orifice 111A can be provided in an inlet passage 111 from the piston side chamber 12B to the blow valve 140, which is provided as a part of the back pressure introduction path 110 in the space 27.

When the piston speed (the moving speed of the piston 24) of the hydraulic shock absorber 10 reaches a high-frequency input, the oil liquid of the piston side chamber 12B is difficult to introduce to the side of the blow valve 140 and the compression side back pressure chamber 101 on the basis of a resistance of the introduction side orifice 111A. The pressure of the back pressure chamber 101 is not increased. When the piston speed of the hydraulic shock absorber 10 reaches a low-frequency input, the oil liquid of the piston side chamber 12B easily passes through the introduction side orifice 101A so as to be easily introduced to the blow valve 140 and the compression side back pressure chamber 101. The pressure of the back pressure chamber 101 is increased.

Further, in the compression side damping force adjusting apparatus 100, the leak path 120 mentioned above is formed in a leading end portion of the backup collar 102, and a leak side orifice 121A can be formed by a slit 121 of the leak path 120.

The compression side damping force adjusting apparatus 100 creates a flow path area of the leak side orifice 121A smaller than the introduction side orifice 11LA, and maintains the pressure of the expansion side back pressure chamber 101 introduced via the introduction side orifice 111A constant by a resistance of the leak side orifice 121A.

Accordingly, the compression side damping force adjusting apparatus 100 is actuated as follows.

(1) When the piston speed (the moving speed of the piston 24) of the hydraulic shock absorber 10 reaches a high-frequency input, the oil liquid of the piston side chamber 12B is difficult to introduce to the side of the blow valve 140 and the compression side back pressure chamber 101, on the basis of the resistance of the introduction side orifice 111A provided in the inlet passage 111 of the space 27. The pressure of the back pressure chamber 101 is not increased. Accordingly, the valve opening pressure of the compression side damping valve 34 becomes low, the compression side damping valve 34 is easily opened, and the compression side damping force of the compression side damping valve 34 becomes low.

(2) When the piston speed of the hydraulic shock absorber 10 reaches the low-frequency input, the oil liquid of the piston side chamber 12B easily passes through the introduction side orifice 111A so as to be easily introduced to the side of the blow valve 140 and the compression side back pressure chamber 101. The pressure of the back pressure chamber 101 is increased on the basis of a control motion as mentioned below of the blow valve 140. The valve opening pressure of the compression side damping valve 34 becomes high, the compression side damping valve 34 is difficult to open, and the compression side damping force of the compression side damping valve 34 becomes high.

(3) The pressure of the compression side back pressure chamber 101 is leaked to the rod side chamber 12A from the leak side orifice 121A provided in the leak path 120 in the leading end portion of the backup collar 102. A leak amount of the pressure of the compression side back pressure chamber 101 is stably controlled by the leak side orifice 121A. It is possible to maintain the pressure of the back pressure chamber 101 constant, and it is possible to stably maintain the damping force characteristic of the compression side damping valve 34.

Accordingly, in the compression side damping force adjusting apparatus 100, to increase the pressure of the compression side back pressure chamber 101 so as to maintain the high damping force of the compression side damping valve 34 during periods when the piston speed of the hydraulic shock absorber 10 is increased, the blow valve 140 blowing the oil liquid having the fixed pressure or higher of the piston side chamber 12B to the back pressure chamber 101 is provided in the inner portion of the valve case 130 interposed in the back pressure introduction path 110 mentioned above, for introducing the oil liquid of the piston side chamber 12B to the back pressure chamber 101.

The blow valve 140 is incorporated in the valve case 130 mentioned above and is installed to the outer periphery of the piston rod 13 so as to be fixed. The valve case 130 is structured such that a hollow shaft 134 provided in the center portion of a tube box 133 in which both upper and lower ends are closed is installed to the outer periphery of the piston rod 13. The valve case 130 is provided with the inlet 132A communicating with the piston side chamber 12B via the inlet passage 111 of the spacer 27 in a bottom plate of the tube box 133, and is provided with the outlet 132B communicating with the back pressure introduction path 110 of the piston rod 13 in the hollow shaft 134. The blow valve 140 is formed as an annular body sliding in a liquid tight manner with each of an inner periphery of the tube box 133 of the valve case 130 and an outer periphery of the hollow shaft 134 via a seal member. The blow valve 140 is formed as a two-stage structure comprising a first pressure receiving portion 141 facing the inlet 132A of the valve case 130 while forming a high step shape in an inner peripheral side, and a second pressure receiving portion 142 forming a lower step shape than the first pressure receiving portion 141 in an outer peripheral side of the first pressure receiving portion 141, in a lower end surface of the annular body. The blow valve 140 is formed so as to pass through a passage 143 conducting a lower chamber 136A corresponding to a side communicating with the piston side chamber 12B, and an upper chamber 136B corresponding to a side communicating with the rod side chamber 12A in the valve case 130 during opening of the valve, up and down the annular body within the second pressure receiving portion 142. The blow valve 140 is structured such that a valve spring 135 is interposed between an upper end surface of the annular body and an upper plate of the tube box 133. An outer peripheral edge of the first pressure receiving portion 141 is brought into pressure contact with an opening edge of the inlet 132A by a spring force of the valve spring 135, thereby being closed. Accordingly, the blow valve 140 receives the pressure of the piston side chamber 12B in the first pressure receiving portion 141 before opening the valve (during closing of the valve) and after opening the valve, and receives the pressure of the piston side chamber 12B in the second pressure receiving portion 142 after opening the valve. In this case, the blow valve 140 is provided with a passage 143A communicating with the outlet 132B of the valve case 130 in a boss portion provided in an upper end surface of the annular body sliding with the outer periphery of the hollow shaft 134 of the valve case 130.

The blow valve 140 is accessorily provided with a differential pressure generating means 137 lowering the pressure of the upper chamber 136B corresponding to the side communicating with the back pressure chamber 101 with respect to the pressure of the lower chamber 136A corresponding to the side communicating with the piston side chamber 12B, after the valve opening. The differential pressure generating means 137 in accordance with the present embodiment is constructed by a plate valve 137A. The plate valve 137A comprises an annular plate additionally provided in an upper end surface of an annular body of the blow valve 140. The plate valve 137A fixes the annular center portion of the annular plate around the boss portion provided in the upper end surface of the annular body of the blow valve 140, and closes the passage 143 of the blow valve 140 by the annular portion in the deflection deformable outer peripheral side. The plate valve 137A makes the pressure of the upper chamber 136B lower than the pressure of the lower chamber 136A on the basis of a deflection resistance loss which the plate valve 137A applies to the oil liquid flowing to the upper chamber 136B from the lower chamber 136A via the passage 143, while deflection deforming the plate valve 137A after opening the blow valve 140.

Accordingly, the hydraulic shock absorber 100 is provided with the blow valve 140 and is actuated as follows (FIG. 4).

(1) If the piston moving speed V/P is increased and the pressure of the rod side chamber 12A or the piston side chamber 12B is increased in the expansion and contraction stroke of the hydraulic shock absorber 10, the expansion side damping valve 33 and the compression side damping valve 34 are opened, and the expansion side damping force TF and the compression side damping force CF are generated.

(2) If the piston moving speed V/P is further increased so as to reach a fixed speed in the compression stroke of the hydraulic shock absorber 10, and the pressure of the piston side chamber 12B is increased so as to reach a fixed pressure (a valve opening pressure of the blow valve 140), the blow valve 140 receives the pressure in the first pressure receiving portion 141 (a narrow pressure receiving surface) so as to be opened. The blow valve 140 blows the high-pressure oil liquid of the piston side chamber 12B to the back pressure chamber 101 of the compression side damping valve 34 via the lower chamber 136A of the valve case 130, the passage 143 of the blow valve 140, the upper chamber 136B of the valve case 130, the back pressure introduction path 110 and the like. Accordingly, the pressure of the back pressure chamber 101 is increased, and the damping force by the compression side damping valve 34 becomes higher.

(3) After the valve opening mentioned in the item (2) of the blow valve 140, the pressure of the piston side chamber 12B is lowered by blowing, and is further lowered by the low speed of the piston moving speed V/P. However, the blow valve 140 receives the lowered pressure of the piston side chamber 12B by both (a wide pressure receiving surface) the first pressure receiving portion 141 and the second pressure receiving portion 142, so as to keep opening.

Further, after the valve opening mentioned in the item (2) of the blow valve 140, the differential pressure generating means 137 constituted by the plate valve 137A lowers the pressure of the upper chamber 136B with respect to the pressure of the lower chamber 136A. The differential pressure between the lower chamber 136A and the upper chamber 136B keeps opening the blow valve 140, and keeps increasing the pressure of the back pressure chamber 101 by extension, thereby maintaining the damping force by the compression side damping valve 34 at a high level.

In accordance with the present embodiment, the following operations and effects can be achieved.

(a) In the damping force adjusting structure of the hydraulic shock absorber 10, the blow valve 140 is provided in the back pressure introduction path 110 introducing the oil liquid of the pressurized piston side chamber 12B to the compression side back pressure chamber 101 during a period of controlling the pressure of the compression side back pressure chamber 101 provided in the back surface side of the compression side damping valve 34, so as to adjust the damping force. Accordingly, if the piston moving speed reaches the fixed speed, and the pressure of the piston side chamber 12B reaches the valve opening pressure of the blow valve 140, the blow valve 140 is opened so as to blow the high-pressure oil liquid of the piston side chamber 12B to the compression side back pressure chamber 101. The pressure of the compression side back pressure chamber 101 is increased, whereby the damping force generated by the compression side damping valve 34 becomes high.

(b) At this time, the blow valve 140 has the first pressure receiving portion 141 capable of receiving the pressure of the piston side chamber 12B before and after opening the valve, and the second pressure receiving portion 142 capable of receiving the pressure of the piston side chamber 12B after opening the valve (two staged pressure receiving surface). Accordingly, the blow valve 140 receives the pressure of the piston side chamber 12B only by the first pressure receiving portion 141 (the narrow pressure receiving surface) until the pressure of the piston side chamber 12B reaches the valve opening pressure of the blow valve 140 so as to be opened. The valve opening pressure of the blow valve 140 is defined by the valve spring 135 and an area of the first pressure receiving portion 141. After the blow valve 140 is opened, the pressure of the piston side chamber 12B is lowered by blowing, and is lowered by the low speed of the piston moving speed. However, the blow valve 140 receives the lowered pressure of the piston side chamber 12B by both (the wide pressure receiving surface) of the first pressure receiving portion 141 and the second pressure receiving portion 142, so as to keep opening. Accordingly, the blow valve 140 stably keeps opening (does not generate any unstable pulsation repeating opening and closing) after being once opened, and keeps increasing the pressure of the compression side back pressure chamber 101, thereby maintaining the damping force generated by the compression side damping valve 34.

(c) In a behavior of the vehicle, since the piston moving speed is high just after turning the steering wheel, for example, during cornering, the blow valve 140 is opened to generate a high damping force and control rolling. Further, if the piston moving speed becomes low after the midfield of the cornering, the blow valve 140 is kept open by the two staged pressure receiving surface mentioned above of the blow valve 140, and rolling is controlled by maintaining the high damping force.

(d) In the present invention, where the piston moving speed is low, ride quality is improved by a soft damping force characteristic having a low rigidity of the compression side damping valve 34 itself without increasing the pressure of the compression side back pressure chamber 101. Further, where the piston moving speed is high, the damping force is increased by increasing the pressure of the compression side back pressure chamber 101 so as to increase the deflection rigidity of the compression side damping valve 34, and steering stability is improved.

(e) The blow valve 140 is provided with the differential pressure generating means 137 lowering the pressure in the side communicating with the rod side chamber 12A of the blow valve 140 with respect to the pressure in the side communicating with the piston side chamber 12B of the blow valve 140 after being opened. Even if the pressure of the piston side chamber 12B is further lowered than the item (b) mentioned above, it is possible to keep opening the blow valve 140 on the basis of the differential pressure.

(f) Since the differential pressure generating means 137 comprises the plate valve 137A, it is possible to generate the differential pressure by setting the deflection rigidity of the plate valve 137A, and it is possible to keep opening the blow valve 140.

(g) Since the introduction side orifice 111A is provided in the inlet passage 111 from the piston side chamber 12B to the blow valve 140, it is possible to delay pressure propagation from the piston side chamber 12B to the blow valve 140. Further, in the case that the piston moving speed reaching a high frequency, it is possible to carry out a frequency depending type damping force adjustment maintaining the valve closing of the blow valve 140 without transmitting the pressure of the piston side chamber 12B to the blow valve 140.

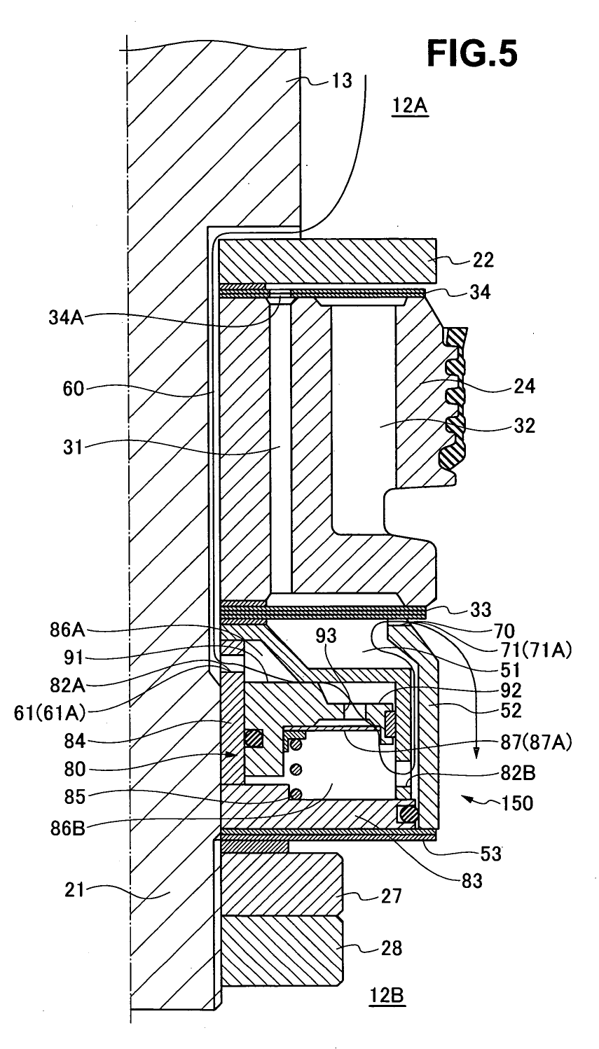

### (Embodiment 3) (FIG. 5)

The hydraulic shock absorber 10 shown in FIG. 5 has an expansion side damping force adjusting apparatus 150 which is substantially the same as the expansion side damping force adjusting apparatus 50 in the embodiment 1. The expansion side damping force adjusting apparatus 150 is different from the expansion side damping force adjusting apparatus 50 in that the backup collar 52 and the plate spring 53 forming the expansion side back pressure chamber 51, and the blow valve 90 incorporated in the valve case 80, are provided between the expansion side damping valve 33 provided in the lower side surface of the piston 24 and the space 27.

In other words, the expansion side damping force adjusting apparatus 150 is structured such that the valve case 80 (the tube box 83 and the hollow shaft 84) and the plate spring 53 are pinched and fixed between the expansion side damping valve 33 and the space 27 in the outer periphery of the piston rod 13, and the backup collar 52 is slidably provided in the outer periphery of the tube box 83 of the valve case 80 via the seal member. The back pressure chamber 51 is formed by an upper surface concave portion of the tube box 83 of the valve case 80 provided in the back surface of the expansion side damping valve 33 and the backup collar 52. The front surface of the backup collar 52 is energized and pressed to the expansion side damping valve 33 by the plate spring 53 positioned in the back surface of the backup collar 52. The valve case 80 is provided with the inlet 82A communicating with the rod side chamber 12A via the back pressure introduction path 60 provided in the piston rod 13 in the hollow shaft 84, and is provided with the outlet 82B communicating with the back pressure chamber 51 in the tube box 83.

The valve case 80 has the valve spring 85, the upper chamber 86A, the lower chamber 86B and the plate valve 87A comprising the differential pressure generating means 87, in the same manner as the valve case 80 of the expansion side damping force generating apparatus 50. The blow valve 90 has the first pressure receiving portion 91, the second pressure receiving portion 92 and the passage 93 in the same manner as the blow valve 90 of the expansion side damping force adjusting apparatus 50. Further, the expansion side damping force adjusting apparatus 150 is structured, in the same manner as the expansion side damping force adjusting apparatus 50, such that the inlet 82A provided in the hollow shaft 84 of the valve case 80 is set to the introduction side orifice 61A, the slit-shaped leak path 70 is formed in a part in a circumferential direction of the leading end portion pressed to the expansion side damping valve 33 of he backup collar 52, and the leak side orifice 71A is formed by the slit 71 of the leak path 70.

Accordingly, the expansion side damping force adjusting apparatus 150 of the hydraulic shock absorber 10 has a compact structure in comparison with the expansion side damping force adjusting apparatus 50, and is actuated as follows in the same manner as the expansion side damping force adjusting apparatus 50.

(1) If the piston moving speed V/P is increased and the pressure of the rod side chamber 12A or the piston side chamber 12B is increased in the expansion and contraction stroke of the hydraulic shock absorber 10, the expansion side damping valve 33 and the compression side damping valve 34 are opened, and the expansion side damping force TF and the compression side damping force CF are generated.

(2) If the piston moving speed V/P is further increased so as to reach the fixed speed, and the pressure of the rod side chamber 12A is also increased so as to reach the fixed pressure (the valve opening pressure of the blow valve 90) in the expansion stroke of the hydraulic shock absorber 10, the blow valve 90 receives the pressure by the first pressure receiving portion 91 (the narrow pressure receiving surface) so as to be opened. The blow valve 90 blows the high-pressure oil liquid of the rod side chamber 12A to the back pressure chamber 51 of the expansion side damping valve 33 via the back pressure introduction path 60, the upper chamber 86A of the valve case 80, the passage 93 of the blow valve 90, the lower chamber 86B of the valve case 80 and the like. Accordingly, the pressure of the back pressure chamber 51 is increased, and the damping force generated by the expansion side damping valve 33 becomes high.

(3) After the valve opening in the item (2) mentioned above of the blow valve 90, the pressure of the rod side chamber 12A is lowered by blowing, and is lowered by the low speed of the piston moving speed V/P. However, the blow valve 90 receives the lowered pressure of the rod side chamber 12A by both (the wide pressure receiving surface) the first pressure receiving portion 91 and the second pressure receiving portion 92, so as to keep opening.

Further, after the valve opening in the item (2) mentioned above of the blow valve 90, the differential pressure generating means 87 constructed by the plate valve 87A lowers the pressure of the lower chamber 86B with respect to the pressure of the upper chamber 86A. The differential pressure between the upper chamber 86A and the lower chamber 86B keeps opening the blow valve 90, and keeps increasing the pressure of the back pressure chamber 51 by extension, thereby maintaining the damping force generated by the expansion side damping valve 33 at a high level.

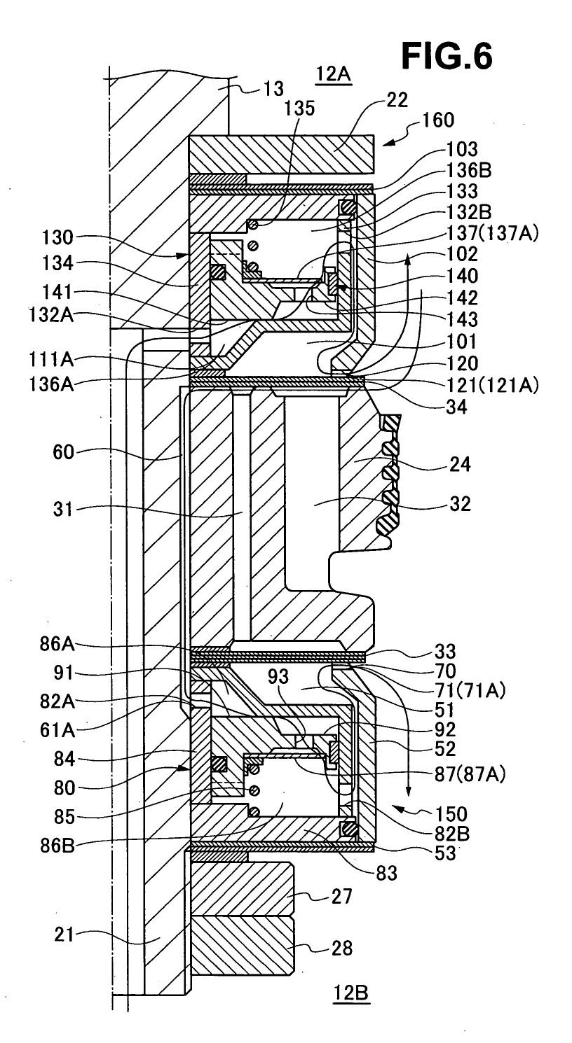

### (Embodiment 4) (FIG. 6)

The hydraulic shock absorber 10 shown in FIG. 6 has a compression side damping force adjusting apparatus 160 which is substantially the same as the compression side damping force adjusting apparatus 100 in accordance with the embodiment 2, in addition to the expansion side damping force adjusting apparatus 150 in accordance with the embodiment 3. The compression side damping force adjusting apparatus 160 is different from the compression side damping force adjusting apparatus 100 in that the backup collar 102 and the plate spring 103 forming the compression side back pressure chamber 101, and the blow valve 140 incorporated in the valve case 130, are provided between the compression side damping valve 34 provided in the upper side surface of the piston 24 and the space 22.

In other words, the compression side damping force adjusting apparatus 160 is structured such that the valve case 130 (the tube box 133 and the hollow shaft 134) and the plate spring 103 are pinched and fixed between the compression side damping valve 34 and the space 22 in the outer periphery of the piston rod 13, and the backup collar 102 is slidably provided in the outer periphery of the tube box 133 of the valve case 130 via the seal member. The back pressure chamber 101 is formed by a lower surface concave portion of the tube box 133 of the valve case 130 provided in the back surface of the compression side damping valve 34 and the backup collar 102. The front surface of the backup collar 102 is energized and pressed to the compression side damping valve 34 by the plate spring 103 positioned in the back surface of the backup collar 102. The valve case 130 is provided with the inlet 132A communicating with the piston side chamber 12B via the back pressure introduction path 110 provided in the piston rod 13 in the hollow shaft 134, and is provided with the outlet 132B communicating with the back pressure chamber 101 in the tube box 133.

The valve case 130 has the valve spring 135, the lower chamber 136A, the upper chamber 136B and the plate valve 137A constructing the differential pressure generating means 137, in the same manner as the valve case 130 of the compression side damping force generating apparatus 100. The blow valve 140 has the first pressure receiving portion 141, the second pressure receiving portion 142, and the passage 143 in the same manner as the blow valve 140 of the compression side damping force adjusting apparatus 100. Further, the compression side damping force adjusting apparatus 160 is structured, in the same manner as the compression side damping force adjusting apparatus 100, such that the inlet 132A provided in the hollow shaft 134 of the valve case 130 is set to the introduction side orifice 111A, the slit-shaped leak path 120 is formed in a part in a circumferential direction of the leading end portion pressed to the compression side damping valve 34 of the backup collar 102, and the leak side orifice 121A is formed by the slit 121 of the leak path 120.

Accordingly, the compression side damping force adjusting apparatus 160 of the hydraulic shock absorber 10 has a compact structure in comparison with the compression side damping force adjusting apparatus 100, and is actuated as follows in the same manner as the compression side damping force adjusting apparatus 100.

(1) If the piston moving speed V/P is increased and the pressure of the rod side chamber 12A or the piston side chamber 12B is increased in the expansion and contraction stroke of the hydraulic shock absorber 10, the expansion side damping valve 33 and the compression side damping valve 34 are opened, and the expansion side damping force TF and the compression side damping force CF are generated.

(2) If the piston moving speed V/P is further increased so as to reach the fixed speed, and the pressure of the piston side chamber 12B is also increased so as to reach the fixed pressure (the valve opening pressure of the blow valve 140) in the compression stroke of the hydraulic shock absorber 10, the blow valve 140 receives the pressure by the first pressure receiving portion 141 (the narrow pressure receiving surface) so as to be opened. The blow valve 140 blows the high-pressure oil liquid of the piston side chamber 12B to the back pressure chamber 101 of the compression side damping valve 34 via the back pressure introduction path 110, the lower chamber 136A of the valve case 130, the passage 143 of the blow valve 140, the upper chamber 136B of the valve case 130 and the like. Accordingly, the pressure of the back pressure chamber 101 is increased, and the damping force generated by the compression side damping valve 34 becomes high.

(3) After the valve opening in the item (2) mentioned above of the blow valve 140, the pressure of the piston side chamber 12B is lowered by blowing, and is lowered by the low speed of the piston moving speed V/P. However, the blow valve 140 receives the lowered pressure of the piston side chamber 12B by both (the wide pressure receiving surface) the first pressure receiving portion 141 and the second pressure receiving portion 142, so as to keep opening.

Further, after the valve opening in the item (2) mentioned above of the blow valve 140, the differential pressure generating means 137 constructed by the plate valve 137A lowers the pressure of the upper chamber 136B with respect to the pressure of the lower chamber 136A The differential pressure between the lower chamber 136A and the upper chamber 136B keeps opening the blow valve 140, and keeps increasing the pressure of the back pressure chamber 101 by extension, thereby maintaining the damping force generated by the compression side damping valve 34 at a high level.

As heretofore explained, embodiments of the present invention have been described in detail with reference to the drawings. However, the specific configurations of the present invention are not limited to the embodiments but those having a modification of the design within the range of the present invention are also included in the present invention. For example, in accordance with the present invention, it is possible to generate the differential pressure, and it is possible to keep opening the blow valve, by setting a throttle of an orifice, by forming the differential pressure generating means by the orifice.

Although the invention has been illustrated and described with respect to several exemplary embodiments thereof it should be understood by those skilled in the art that the foregoing and various other changes, omissions and additions may be made to the present invention without departing from the spirit and scope thereof. Therefore, the present invention should not be understood as limited to the specific embodiment set out above, but should be understood to include all possible embodiments which can be embodied within a scope encompassed and equivalents thereof with respect to the features set out in the appended claims.

What is claimed is:

1. A damping force adjusting structure of a hydraulic shock absorber comprising an oil chamber of a cylinder accommodating an oil liquid therein, a piston slidably fitted and inserted to the cylinder, provided in an insertion end of a piston rod inserted to the cylinder, and a damping valve to control flow of an oil liquid from one oil chamber to the other oil chamber pressurized by a sliding motion of the piston so as to generate a damping force, and
the pressurized oil liquid in the one oil chamber introduced to a back pressure chamber provided in a back surface side of a damping valve, pressure within the back pressure chamber leaked from a leak path, valve opening pressure of the damping valve controlled by controlling the pressure of the back pressure chamber so as to be capable of adjusting the damping force,
a blow valve blowing the oil liquid in the pressurized one oil chamber to the back pressure chamber is provided in a back pressure introduction path introducing the pressurized oil liquid in the one oil chamber to the back pressure chamber, and
wherein the blow valve has a first pressure receiving portion capable of receiving the pressure of the one oil chamber before and after the valve opening, and a second pressure receiving portion capable of receiving the pressure of the one oil chamber after the valve opening.

2. A damping force adjusting structure of a hydraulic shock absorber according to claim 1, wherein said blow valve is provided with a differential pressure generating structure for creating a pressure in a side communicating with the other oil chamber of said blow valve lower than a pressure in a side communicating with the one oil chamber of said blow valve after the valve opening.

3. A damping force adjusting structure of a hydraulic shock absorber according to claim 2, wherein said differential pressure generating comprises a plate valve.

4. A damping force adjusting structure of a hydraulic shock absorber according to claim 2, wherein said differential pressure generating structure comprises an orifice.

5. A damping force adjusting structure of a hydraulic shock absorber according to claim 1, wherein an orifice is provided in a passage from said one oil chamber to the blow valve.

6. A damping force adjusting structure of a hydraulic shock absorber according to claim 2, wherein an orifice is provided in a passage from said one oil chamber to the blow valve.

7. A damping force adjusting structure of a hydraulic shock absorber according to claim 3, wherein an orifice is provided in a passage from said one oil chamber to the blow valve.

8. A damping force adjusting structure of a hydraulic shock absorber according to claim 4, wherein an orifice is provided in a passage from said one oil chamber to the blow valve.

9. A damping force adjusting structure of a hydraulic shock absorber according to claim 1, said blow valve being incorporated in a valve case installed to an outer periphery of said piston rod so as to be fixed, and
wherein said valve case is structured such that a hollow shaft provided in a center portion of a tube box in which both upper and lower ends are closed is installed to an outer periphery of the piston rod, an inlet communicating with the one oil chamber is provided in the tube box, and an outlet communicating with the back pressure introduction path of said piston rod is provided in the hollow shaft.

10. A damping force adjusting structure of a hydraulic shock absorber according to claim 2, said blow valve being incorporated in a valve case installed to an outer periphery of said piston rod so as to be fixed, and
wherein said valve case is structured such that a hollow shaft provided in a center portion of a tube box in which both upper and lower ends are closed is installed to, an outer periphery of the piston rod, an inlet communicating with the one oil chamber is provided in the tube box, and an outlet communicating with the back pressure introduction path of said piston rod is provided in the hollow shaft.

11. A damping force adjusting structure of a hydraulic shock absorber according to claim 3, said blow valve being incorporated in a valve case installed to an outer periphery of said piston rod so as to be fixed, and
wherein said valve case is structured such that a hollow shaft provided in a center portion of a tube box in which both upper and lower ends are closed is installed to an outer periphery of the piston rod, an inlet communicating with the one oil chamber is provided in the tube box, and an outlet communicating with the back pressure introduction path of said piston rod is provided in the hollow shaft.

12. A damping force adjusting structure of a hydraulic shock absorber according to claim 4, said blow valve being incorporated in a valve case installed to an outer periphery of said piston rod so as to be fixed, and
wherein said valve case is structured such that a hollow shaft provided in a center portion of a tube box in which both upper and lower ends are closed is installed to an outer periphery of the piston rod, an inlet communicating with the one oil chamber is provided in the tube box, and an outlet communicating with the back pressure introduction path of said piston rod is provided in the hollow shaft.

13. A damping force adjusting structure of a hydraulic shock absorber according to claim 9, wherein said blow valve forms an annular body sliding in a liquid tight manner with each of an inner periphery of the tube box of said valve case, and an outer periphery of said hollow shaft.

14. A damping force adjusting structure of a hydraulic shock absorber according to claim 10, wherein said blow valve forms an annular body sliding in a liquid tight manner with each of an inner periphery of the tube box of said valve case, and an outer periphery of said hollow shaft.

15. A damping force adjusting structure of a hydraulic shock absorber according to claim 11, wherein said blow valve forms an annular body sliding in a liquid tight manner with each of an inner periphery of the tube box of said valve case, and an outer periphery of said hollow shaft.

16. A damping force adjusting structure of a hydraulic shock absorber according to claim 12, wherein said blow valve forms an annular body sliding in a liquid tight manner with each of an inner periphery of the tube box of said valve case, and an outer periphery of said hollow shaft.

17. A damping force adjusting structure of a hydraulic shock absorber according to claim 9, said first pressure receiving portion faces the inlet of said valve case while forming an end surface of said annular body as a high step shape in an inner peripheral side, and
wherein said second pressure receiving portion is formed as a lower step shape than the first pressure receiving portion in an outer periphery of said first pressure receiving portion.

18. A damping force adjusting structure of a hydraulic shock absorber according to claim 10, said first pressure receiving portion faces the inlet of said valve case while forming an end surface of said annular body as a high step shape in an inner peripheral side, and
wherein said second pressure receiving portion is formed as a lower step shape than the first pressure receiving portion in an outer periphery of said first pressure receiving portion.

19. A damping force adjusting structure of a hydraulic shock absorber according to claim 11, said first pressure receiving portion faces the inlet of said valve case while forming an end surface of said annular body as a high step shape in an inner peripheral side, and
wherein said second pressure receiving portion is formed as a lower step shape than the first pressure receiving portion in an outer periphery of said first pressure receiving portion.

20. A damping force adjusting structure of a hydraulic shock absorber according to claim 12, said first pressure receiving portion faces the inlet of said valve case while forming an end surface of said annular body as a high step shape in an inner peripheral side, and
wherein said second pressure receiving portion is formed as a lower step shape than the first pressure receiving portion in an outer periphery of said first pressure receiving portion.
